(19) United States
(12) Patent Application Publication
(10) Pub. No.: US 2015/0006270 A1
(43) Pub. Date: Jan. 1, 2015

(54) PAYMENT AND REWARD OPTIMIZATION IN ELECTRONIC COMMERCE SYSTEM

(71) Applicants: Wei Xu, Millwood, NY (US); Elizabeth Platko, Cortlandt Manor, NY (US)

(72) Inventors: Wei Xu, Millwood, NY (US); Elizabeth Platko, Cortlandt Manor, NY (US)

(73) Assignee: MASTERCARD INTERNATIONAL INCORPORATED, Purchase, NY (US)

(21) Appl. No.: 13/927,490

(22) Filed: Jun. 26, 2013

(51) Int. Cl. G06Q 30/02; G06Q 20/10; G06Q 20/22

(52) U.S. Cl. CPC G06Q 30/0222; G06Q 20/227; G06Q 20/10
USPC 705/14.23; 705/39

(57) ABSTRACT

Using at least one computer processor, a first input is received from a payor. The first input specifies a payee account for a transaction. For each payment source among a plurality of payment sources available to the payor, the application computes a processing cost associated with said payment source for the transaction, or a net cost to the payor associated with said payment source for the transaction, or both. An indication of one of the payment sources is displayed to the payor. The indication indicates that said one payment source is optimal according to a predetermined criterion. For each payment source, said associated processing cost and/or said associated net cost is/are displayed to the payor. A payment is processed to the payee account using one of the payment sources, which may be the payment source that was determined to be optimal or another payment source.

### FIELD

Aspects of the present disclosure relate in general to electronic commerce systems, and more particularly to payment optimization and reward optimization in electronic commerce systems.

### BACKGROUND

Electronic wallets (sometimes referred to as digital wallets) have become popular for conducting a variety of financial transactions electronically. A user accesses her electronic wallet through a program or application, e.g., during the checkout phase in an electronic commerce (e-commerce) application. Electronic wallets typically have data associated with various cards (e.g., physical credit or debit cards) and/or accounts, e.g., real or virtual accounts or sub-accounts.

The use of rewards programs (sometimes called incentive programs) has become common in recent years. Some credit cards offer consumers the ability to receive a benefit based on purchases that are charged to the credit cards. The benefits typically include cash (e.g., a cash back amount that is based on the purchase amount, such as 1% cash back from all purchases) or points that may be accumulated and later redeemed for various goods or services. Some credit cards offer rewards based on the type of transaction that a consumer makes (e.g., 2% cash back for all gas and grocery purchases and 1% cash back for all other purchases) or based on the applicable merchant from whom the consumer makes a purchase (e.g., 3% off from selected merchants). Cards that enable consumers to avail themselves of such benefits are referred to as rewards cards. Due to the proliferation in rewards programs and the increase in the number of cards that consumers carry and use on an everyday basis, the task of paying for items with rewards cards has become complicated and often inefficient.

### SUMMARY

In an embodiment of the present disclosure that corresponds to a computer-implemented method, using at least one computer processor, a first input is received from a payor. The first input specifies a payee account for a transaction. For each payment source among a plurality of payment sources available to the payor, the application computes a processing cost associated with said payment source for the transaction, or a net cost to the payor associated with said payment source for the transaction, or both. An indication of one of the payment sources is displayed to the payor. The indication indicates that said one payment source is optimal according to a predetermined criterion. For each payment source, said associated processing cost and/or said associated net cost is/are displayed to the payor. A payment is processed to the payee account using one of the payment sources, which may be the payment source that was determined to be optimal or another payment source.

In another embodiment corresponding to a computer-implemented method, using at least one computer processor, a first input is received from a payor. The first input specifies one or more items to be purchased in a transaction. Reward data associated with the payee account is retrieved. The reward data specifies one or more discounts available to the payor for the transaction. For each payment source among a plurality of payment sources available to the payor, the application computes a processing cost associated with said payment source for the transaction, or a net cost to the payor associated with said payment source for purchase of the items, or both. The application automatically determines one of the payment sources that is optimal according to a predetermined criterion. A payment for the items is processed to the payee account using one of the payment sources, wherein the payment uses at least one of the available discounts.

In some embodiments, a non-transitory computer readable storage medium comprises instructions stored thereon. When executed, the instructions cause a computer processor to perform the operations of the computer-implemented methods described above.

### BRIEF DESCRIPTION OF THE DRAWINGS

The following will be apparent from elements of the figures, which are provided for illustrative purposes and are not necessarily to scale.

FIGS. 1A and 1B are block diagrams of system embodiments configured to enable payment and reward optimization.

FIG. 2 is a block diagram of a computer architecture in accordance with certain embodiments of the present disclosure.

FIG. 3 is a diagram illustrating an example collection of accounts, sub-accounts, and cards in accordance with certain embodiments.

FIG. 4 is a diagram illustrating an example external wallet hierarchy in accordance with certain embodiments.

FIG. 5 is a flow diagram of a process for payment and reward optimization in the context of payment to an external wallet.

FIG. 6 is a flow diagram of a process for payment and reward optimization in the context of direct payment to a payee.

FIG. 7 is an electronic wallet layout in accordance with certain embodiments.

FIG. 8 is a flow diagram of a process in accordance with certain embodiments.

FIG. 9 is a flow diagram of another process in accordance with certain embodiments.

### DETAILED DESCRIPTION

This description of the exemplary embodiments is intended to be read in connection with the accompanying drawings, which are to be considered part of the entire written description.

Various embodiments of the present disclosure provide payment or reward optimization functionality to enable consumers to derive increased value in electronic transactions.

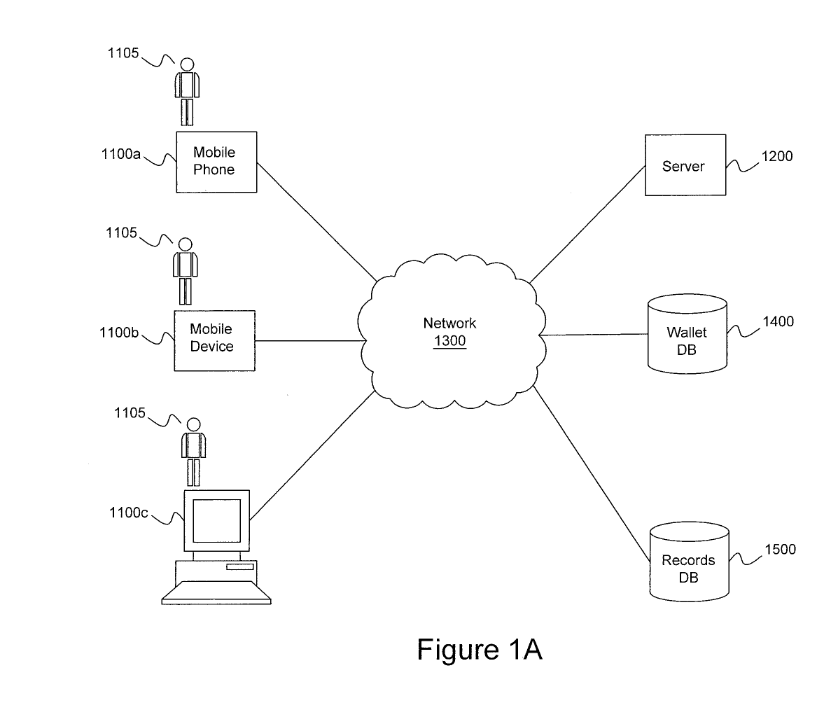

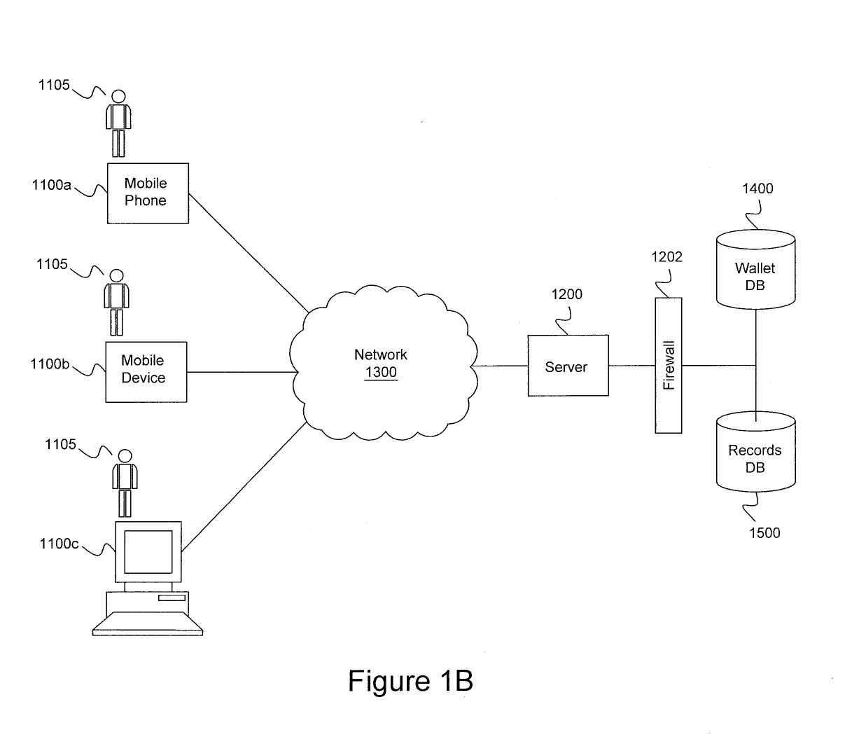

FIG. 1A is a block diagram of a system embodiment configured to enable payment and/or reward optimization for electronic commerce transactions. A user 1105 may access functionality related to the transfer of electronic funds by using a mobile phone 1100a, mobile device 1100b (e.g., tablet-type device), personal computer (e.g., desktop or notebook computer) 1100c, a television, or any other network-accessible computing device (any of the foregoing devices may be referred to generally as “user device 1100”) to access network 1300, which may be the Internet or may be connected to the Internet. A server 1200 is a network-side (relative to the user, which can be considered a client) computer that may be associated with a transaction solution provider (e.g., a company that enables or supports the user to perform commerce transactions electronically). Server 1200 is capable of communication with user device 1100 via network 1300. In various embodiments, user device 1100 is configured to receive instructions and software updates from server 1200 via network 1300.

In some embodiments, the user 1105 accesses financial transaction functionality in her own individual capacity, e.g., regarding her personal credit cards or accounts. In other embodiments, the user 1105 accesses financial transaction functionality on behalf of an organization or company with which she is associated or affiliated. For example, user 1105 may be the principal or other employee of a school that has various credit cards or accounts, or she may be an administrator or operator of a computerized financial system of a company.

In some embodiments, the user 1105 accesses financial transaction functionality using a web interface, e.g., by using a web browser at user device 1100 to access a website. For example, the user device may use a web protocol (e.g., HTTP or IMPS) to contact a web server (which may be server 1200 or a different computer connected to network 1300) which serves web page(s) that the browser at the user device 1100 can render on a display. In other embodiments, the user accesses financial transaction functionality by using an application (e.g., an application running on a smartphone) that communicates with server 1200 through a communication protocol other than a web protocol.

Various databases may be connected to server 1200 to store information related to electronic transactions. For example, as shown in FIG. 1A, a wallet database 1400 and a records database 1500 may be connected to server 1200 via network 1300. Various network configurations can be used. In some embodiments, the wallet database 1400 and records database 1500 are directly connected to the server 1200 or are configured as shown in FIG. 1B, with a firewall 1202 protecting these databases. In the example of FIG. 1B, the server 1200, which may be referred to as a processing server, has permission to pass (cross) the firewall 1202 to retrieve from the wallet database 1400 and from the records database 1500. The wallet database 1400 may store information regarding various electronic wallets, e.g., identification information (e.g., name, address, phone number, e-mail address), account information (e.g., financial details such as routing and account numbers), and/or information regarding the current status of the wallet (e.g., amount of funds, security permissions). For example, wallet database 1400 may store data related to multiple external wallets. The records database 1500 can store various records related to transactions, e.g., for maintaining a transaction history for users.

The network topology diagrams in FIGS. 1A-1B are simplified views, and additional components may be present. For example, a firewall (not shown) may be used within network 1300 for security purposes, and an intranet may be used to connect such a firewall to the server 1200.

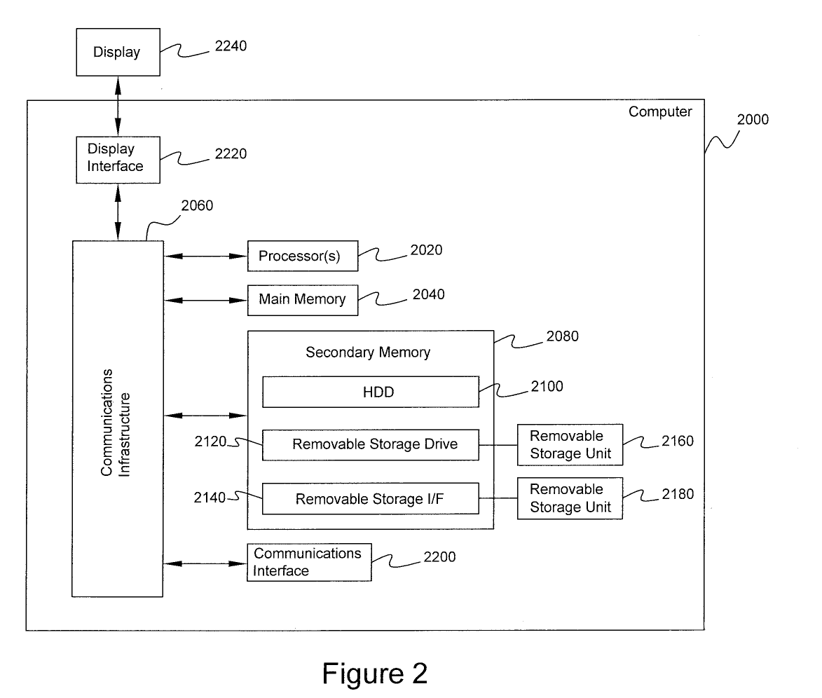

FIG. 2 is a block diagram of a computer architecture in accordance with certain embodiments of the present disclosure. Computer system 2000 may be an example implementation of server 1200 and/or user device 1100. As illustrated in FIG. 2, computer system 2000 may include one or more processors 2020. Each processor 2020 is connected to a communication infrastructure 2060 (e.g., a communications bus, cross-over bar, or network). Computer system 2000 may include a display interface 2220 that forwards graphics, text, and other data from the communication infrastructure 2060 (or from a frame buffer, not shown) for display on the display unit 2240.

Computer system 2000 may also include a main memory 2040, such as a random access memory (RAM), and a secondary memory 2080. The secondary memory 2080 may include, for example, a hard disk drive (HDD) 2100 and/or removable storage drive 2120, which may represent a floppy disk drive, a magnetic tape drive, an optical disk drive, a memory stick, or the like as is known in the art. The removable storage drive 2120 reads from and/or writes to a removable storage unit 2160. Removable storage unit 2160 may be a floppy disk, magnetic tape, optical disk, or the like. As will be understood, the removable storage unit 2160 may include a computer readable storage medium having tangibly stored therein (embodied thereon) data and/or computer software instructions, e.g., for causing the processor(s) to perform various operations.

In alternative embodiments, secondary memory 2080 may include other similar devices for allowing computer programs or other instructions to be loaded into computer system 2000. Secondary memory 2080 may include a removable storage unit 2180 (which may be similar to removable storage unit 2160) and a corresponding interface 2140, which may be similar to removable storage drive 2120. Examples of such removable storage units include, but are not limited to, USB or flash drives, which allow software and data to be transferred from the removable storage unit 2180 to computer system 2000.

Computer system 2000 may also include a communications interface 2200. Communications interface 2200 allows software and data to be transferred between computer system 2000 and external devices. Examples of communications interface 2200 may include a modem, Ethernet card, wireless network card, a Personal Computer Memory Card International Association (PCMCIA) slot and card, or the like. Software and data transferred via communications interface 2200 may be in the form of signals, which may be electronic, electromagnetic, optical, or the like that are capable of being received by communications interface 2200. These signals may be provided to communications interface 2200 via a communications path (e.g., channel), which may be implemented using wire, cable, fiber optics, a telephone line, a cellular link, a radio frequency (RF) link and other communication channels.

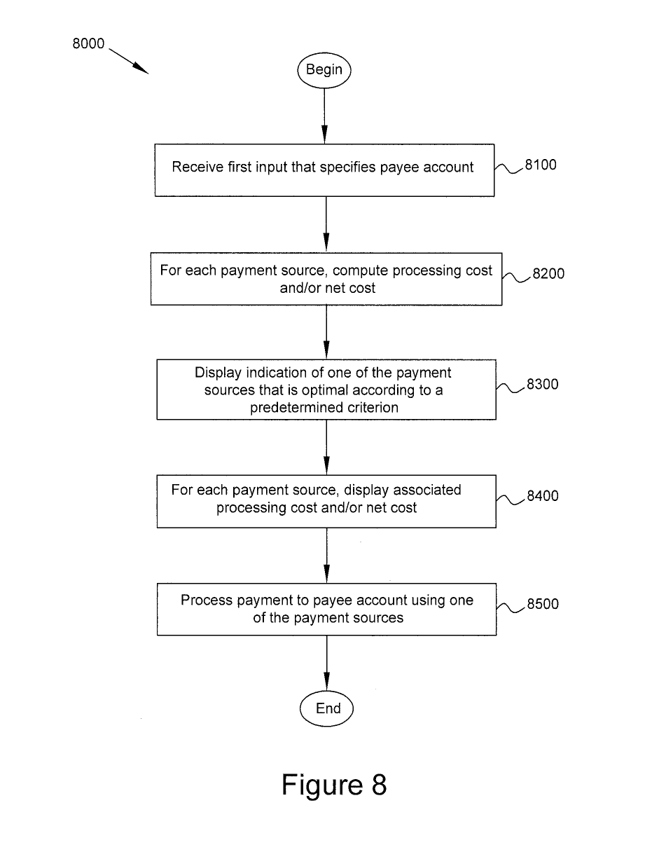

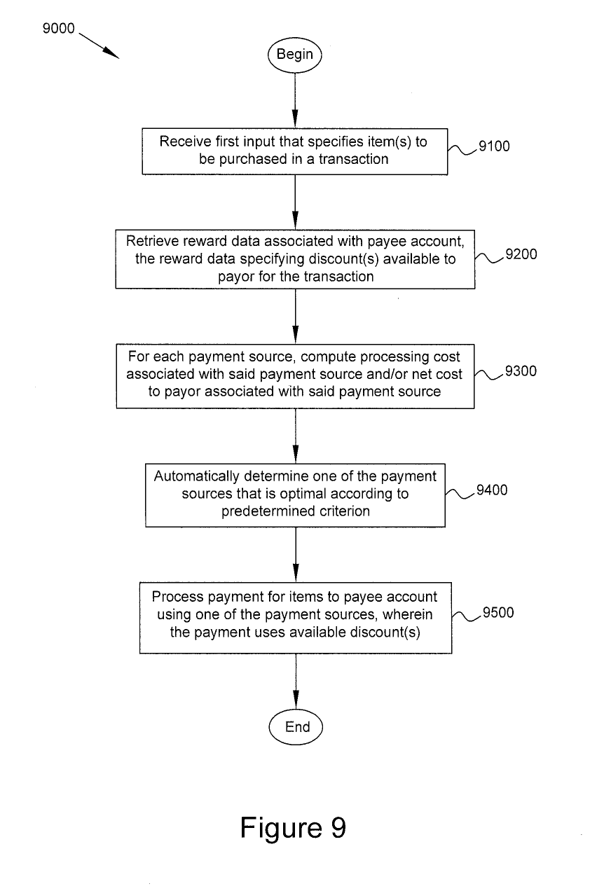

In this document, the terms “computer program medium” and “non-transitory computer readable storage medium” refer to media such as, but not limited to, media at removable storage drive 2120, or a hard disk installed in hard disk drive 2100, or removable storage unit 2160. These computer program products provide software to computer system 2000. Computer programs (also referred to as computer control logic) may be stored in main memory 2040 and/or secondary memory 2080. Computer programs may also be received via communications interface 2200. Such computer programs, when executed by a processor, enable the computer system 2000 to perform the features of the methods discussed herein. For example, main memory 2040, secondary memory 2080, or removable storage units 2160 or 2180 may be encoded with computer program code (instructions) for performing operations corresponding to various processes disclosed herein, e.g., processes 8000 and 9000 discussed below in the context of FIGS. 8-9.

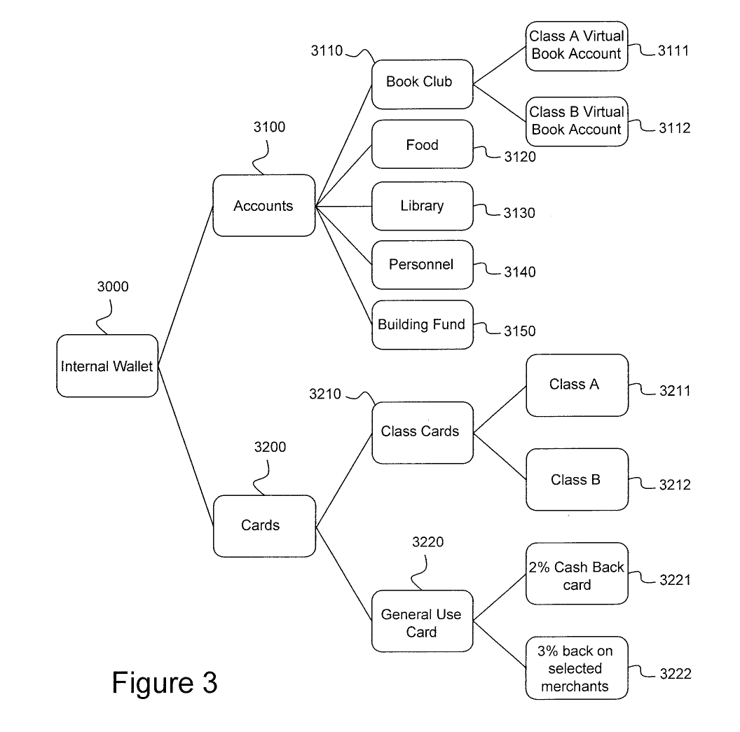

FIG. 3 is a diagram illustrating an example collection of accounts, sub-accounts, and cards in accordance with certain embodiments. An electronic wallet may contain information regarding various accounts (e.g., bank accounts) and cards (e.g., credit or debit cards), which may be structured in a tree-like hierarchy as shown in FIG. 3. FIG. 3 depicts an example internal wallet configuration for an organization such as a school or college, and other internal wallet configurations may be applicable for other types of organizations or for individuals. The term “internal wallet” refers to the fact that this wallet contains information regarding the organization's (in this case, the school's) own accounts and/or cards. In contrast, an external wallet may contain content regarding various parties (e.g., vendors who provide goods or services to the school) to whom payments are to be made or from whom payments are received, for example.

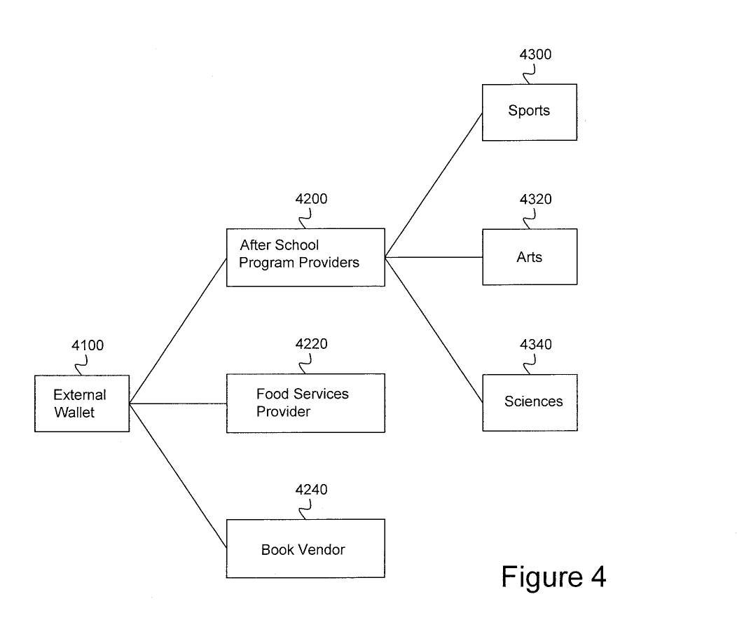

An example of a virtual external wallet having a tree-like hierarchy is shown in FIG. 4. In FIG. 4, under the root category of external wallet 4100, there are various individual external wallets and subwallets. External wallets 4220 and 4240 correspond to a food service provider and a book vendor, respectively, in the example where the organization is a school. Under the category “after school program providers” 4200 there are subwallets 4300, 4320 and 4340 corresponding to sports, arts, and science program providers, respectively. A hierarchical external wallet configuration as in FIG. 4 may be used to enable the aggregation of expenditure summaries for different activities or vendors.

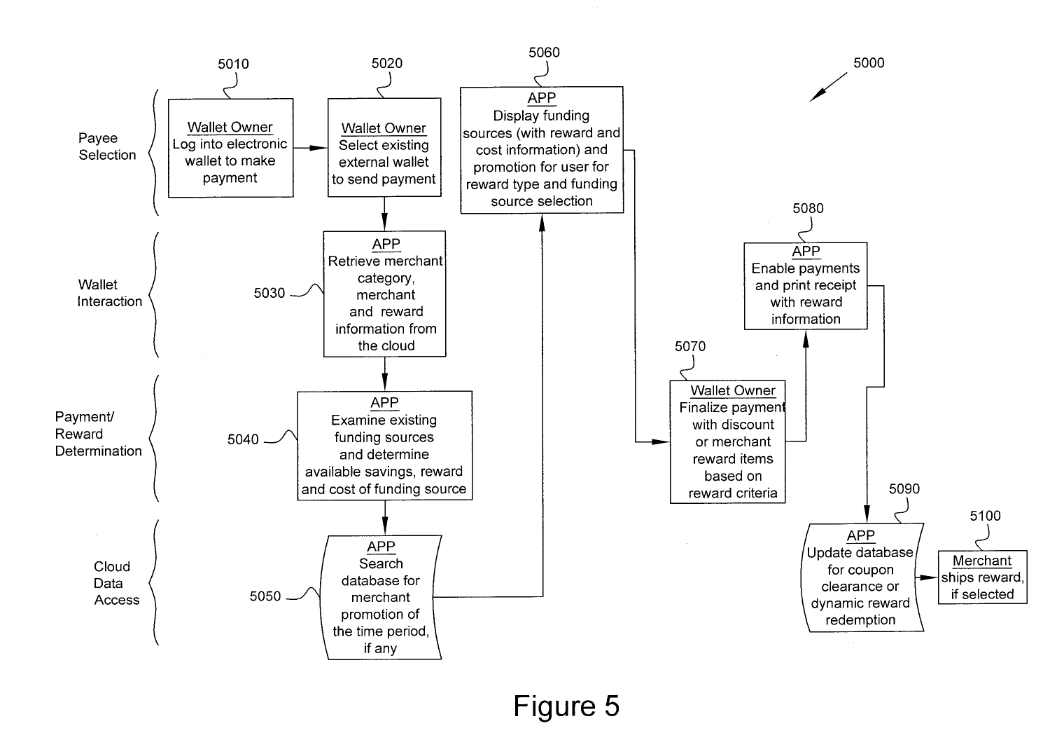

The external wallet(s) may be digital wallets corresponding to payees (entities that receive payment) in certain embodiments. FIG. 5 is a flow diagram of a process 5000 for payment and reward optimization in the context of payment to an external wallet. For a private electronic wallet, the user of the wallet is the same as the wallet owner. Although various activities in FIG. 5 are indicated as corresponding to a wallet owner, they may also be performed by a user who may operate and administer the wallet on behalf of a company or organization, e.g., in the case of a commercial or organizational electronic wallet. Activities denoted “APP” in FIG. 5 may be performed by an application (e.g., software program) running on user device 1100. Alternatively, the activities denoted “APP” in FIG. 5 may be performed by an application running on server 1200, e.g., in a configuration in which user device 1100 is used to provide inputs to and receive outputs from the server application. The ability to run the application on server 1200 provides flexibility, e.g., in case user device is lost or is currently off.

The components of the process flow diagram in FIG. 5 are grouped according to the categories of payee selection, wallet interaction, payment/reward determination, and cloud data access (i.e., accessing data that is stored “in the cloud,” e.g., in network-accessible data stores). These groupings are conceptual and are for promoting understanding, and they are not limiting.

The example payment scenario illustrated in FIG. 5 may correspond to a payment from a payor that is a school or other educational institution, to a payee that is a vendor that provides goods or services to the school (e.g., a bookseller that provides books to the school). Other payors and payees are applicable as well.

Referring to FIG. 5, at block 5010, the wallet owner/user logs in to an electronic internal wallet using user device 1100. Various authentication and/or sign-on protocols can be used, e.g., a username/password pair. The internal wallet may be stored at user device 1100 or at wallet database 1400. The data contents of the internal wallet (e.g., accounts, cards, affiliation(s) with vendor(s), affiliation(s) with external wallet(s), unique wallet ID for this internal wallet) may be stored at wallet database 1400. In some embodiments, the unique wallet ID and transaction history, including historical information about incoming funds to be allocated and earned rewards, are stored in records database 1500. Various implementations are possible, and the foregoing data can be stored at different databases. For example, a database may reside on server 1200, in which case strong security protocols and security implementations may be deployed to guard against external access and unauthorized internal access.

At block 5020, the wallet owner/user selects an existing external wallet to which a payment is to be sent (i.e., to which funds are to be transferred). This selection may be implemented by the wallet owner/user inputting data that specifies a payee account for the transaction. The selected external wallet may be one of multiple external wallets that are stored at wallet database 1400 and that correspond to respective payees. For example, multiple external wallets may be displayed (e.g., by displaying respective text or graphical identifiers) to the wallet owner, who selects one of the external wallets.

At block 5030, the application (e.g., software program) retrieves a merchant identifier, merchant category identifier, and reward information from wallet database 1400 or another database connected directly or indirectly to network 1300. As used herein, “merchant identifier” refers to any type of identifier that identifies a specific merchant, and “merchant category identifier” is any type of identifier that identifies a type of merchant. For example, a book vendor such as John Doe's Discount Books may have a merchant identifier that is different from the identifiers corresponding to other merchants, even other merchants that sell books. This book vendor (John Doe's Discount Books) may also have a merchant category identifier that identifies the merchant as a book vendor. Some common merchant categories include grocery stores, gas stations, and department stores. In some embodiments, a merchant category code (MCC), which is a four-digit number assigned to a merchant that accepts certain payment cards for payment, may be used as the merchant category identifier. Any other form of identifier may be used for the merchant category identifier as well.

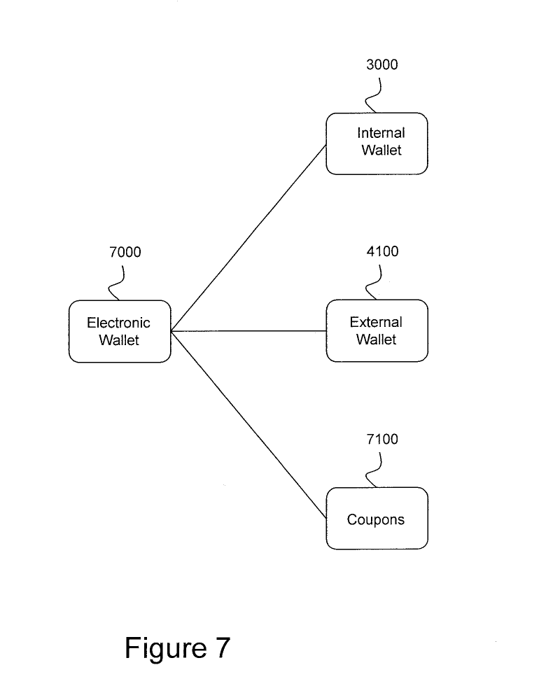

The reward information that is retrieved at block 5030 is information specifying one or more rewards that may be available due to the payment, e.g., a reward that may be provided by a merchant if the payment exceeds a certain amount of funds. Such a reward may be referred to as a merchant-funded reward and may be any type of reward, e.g., a cash back amount or physical goods (such as a free book that a book vendor provides). In some embodiments, the rewards are coupons that can be stored in the electronic wallet for future use or can be applied at the time of purchase. An individual merchant payee may offer the choice of various rewards in exchange for the payment. For example, an individual merchant may offer a choice between various books or cash back. The merchant may also offer a discount or coupon for a selection of books, e.g., a coupon that is redeemable during a promotional time period. As shown in FIG. 7, one or more electronic coupons 7100 may be stored in electronic wallet 7000 along with internal wallet 3000 and external wallet 4100. In some embodiments, coupons 7100 may contain data regarding a discount from a merchant, manufacturer, network, or issuer bank. Coupons from a network or issuer banks may be specific to a time period. Thus, coupons that eventually expire may offer different functionality than card features such as 2% cash back, which may not be restricted to a specific time period.

At block 5040, the application examines various existing funding sources (payment options) and determines, for each funding source, an available reward and a cost. Different funding sources (e.g., different credit cards or accounts) may have different associated rewards and different associated processing costs, as illustrated in Table 1:

TABLE 1
Example funding sources

| | | Net cost of $500 |
|---|---|---|
| Funding source | Processing fee | purchase |
| checking account | $0 | cost to payor = $500 |
| credit card X offering 2% | $5 | cost to payor = $500 − |
| cash back | | ($500 * 0.02) + $5 = $495 |
| credit card Y offering 3% | $7 | cost to payor = $500 − |
| cash back for payments | | ($500 * 0.03) + $7 = $492 |
| to predetermined | | |
| merchants | | |
| credit card Z that offers | $10 | cost to payor = $510 |
| a 5% donation, by a | | donation by processing |
| processing network, to | | network = $25 |
| cancer research for each | | |
| transaction | | |

Table 1 shows various funding sources that may be available to a payor for implementing a payment of $500. A checking account that has a zero processing cost may be used, so that the net cost to the payor would be $500. Alternatively, a first credit card (credit card X) that offers 2% cash back but includes a $5 processing fee may be used, so that the cost to the net payor would be $500−($500*0.02)+$5=$495. Or, a second credit card (credit card Y) that offers 3% cash back for payments to predetermined merchants but includes a $7 processing fee may be used (assuming that the payee in this example is one of the predetermined merchants), so that the net cost to the payor would be $500−($500*0.03)+$7=$492. Another option is a third credit card (credit card Z) which has a $10 processing fee but which causes a processing network (or any other entity) to contribute a 5% donation to a third party (e.g., a cancer research institution that is different from the payor and payee) for each transaction. In other words, such a contribution is contingent upon payment using credit card Z. In this last case, the net cost to the payor would be $510, and the donation by the processing network would be $25. Although monetary rewards are shown in the examples of Table 1, non-monetary rewards may be associated with funding sources.

At block 5050, the application searches a database (e.g., wallet database 1400) for any applicable merchant promotion (promotional offer) that may be available for the present time period (e.g., deal of the month). Merchant promotions may be stored in a database, e.g., on a per-merchant basis, and may be updated dynamically. For example, the payee that is a book vendor may have a deal for the month of May that offers one free textbook for all qualifying purchases (e.g., for purchases that exceed a predetermined purchase amount). The payee may offer a particular fixed reward (a predetermined book) during the relevant time period or may provide the payor with the option of selecting among multiple possible rewards (e.g., among multiple predetermined books).

At block 5060, the application causes one or more available funding sources to be displayed to the wallet owner/user, along with information regarding the associated reward(s) and associated cost (processing cost and/or net cost). The internal wallet may also have some funding sources that do not provide any rewards, and information about such funding sources may also be displayed.

In certain embodiments, the funding sources may be displayed in a predetermined order according to a predetermined criterion, e.g., from lowest to highest net cost or processing cost, or from highest to lowest cash back rate. In this way, the wallet owner/user can quickly see which funding source will have the most favorable financial outcome for her. Alternatively, the funding sources that are associated with contributions by a third party (such as the a 5% donation to cancer research) can be grouped together (e.g., at the front of the displayed list) and/or sorted (e.g., by donation amount) so that a charitably minded wallet owner/user can quickly see the details that are most relevant to her. In some embodiments, only funding sources meeting certain predetermined criteria are displayed. For example, the application can be configured to display only funding sources that involve donations by third parties, or to display only the top N funding sources ranked in order of net cost from highest to lowest or lowest to highest (where N is an integer), or to display only funding sources that yield a net cost (such as $495 in the case of the 2% cash back card of Table 1) that is lower than the base payment amount (which is $500 in the example of Table 1).

The wallet owner/user is prompted to select among the funding sources and/or among the available rewards. At block 5070, in some embodiments, the wallet owner/user may be prompted to finalize (e.g., confirm) the payment that may yield a discount (e.g., cash back) or merchant reward items (e.g., free books).

In some embodiments, a “no-confirmation” mode can be enabled, in which the application automatically selects the optimal funding source according to a predetermined criterion or predetermined criteria. For example, the application may have configurable settings enabling the wallet owner/user to specify whether minimum overall payment (minimum net cost) is the default top priority option and whether payment selection confirmation is required. If the wallet owner/user specified that minimum net cost is the default top priority option and that payment selection confirmation is not needed, then the no-confirmation mode can be enabled. Referring to Table 1, in the no-confirmation mode, credit card Y which offers 3% cash back would be automatically used for payment (assuming the funding sources shown in Table 1 are all the available funding sources), because its associated net cost to the payor ($492) for the specified transaction is minimal compared to the other options. Alternatively, a charitably-minded wallet owner/user can disable the no-confirmation mode (so that her confirmation is required), and she can view all the available funding sources and select credit card Z, which has a higher associated net cost ($510) for the transaction but which results in a donation to cancer research. Thus, various embodiments of the present disclosure provide the wallet owner/user the flexibility to customize payments to her preferences in an efficient manner.

At block 5080, the application enables a payment to be made and may print a receipt including information about the reward(s) received through the transaction.

At block 5090, the application updates a database with information regarding coupon clearance or reward redemption (e.g., so that vendors will be able to track usage of their offered rewards). Various implementations for the database may be used. For enhanced security and processing, in some embodiments, information regarding coupon clearance or reward information is separated (e.g., stored at a different database) from information regarding accounts and cards (which may be stored at wallet database 1400). The wallet may have a pointer indicating the address of the redemption information stored in a different database, e.g., transaction records database 1500. A computer associated with the payee (e.g., a book merchant) can access the updated information and thus act accordingly in response to the transaction. For example, at block 5100, the payee merchant may ship the applicable reward(s) (e.g., free book(s)), if any were selected.

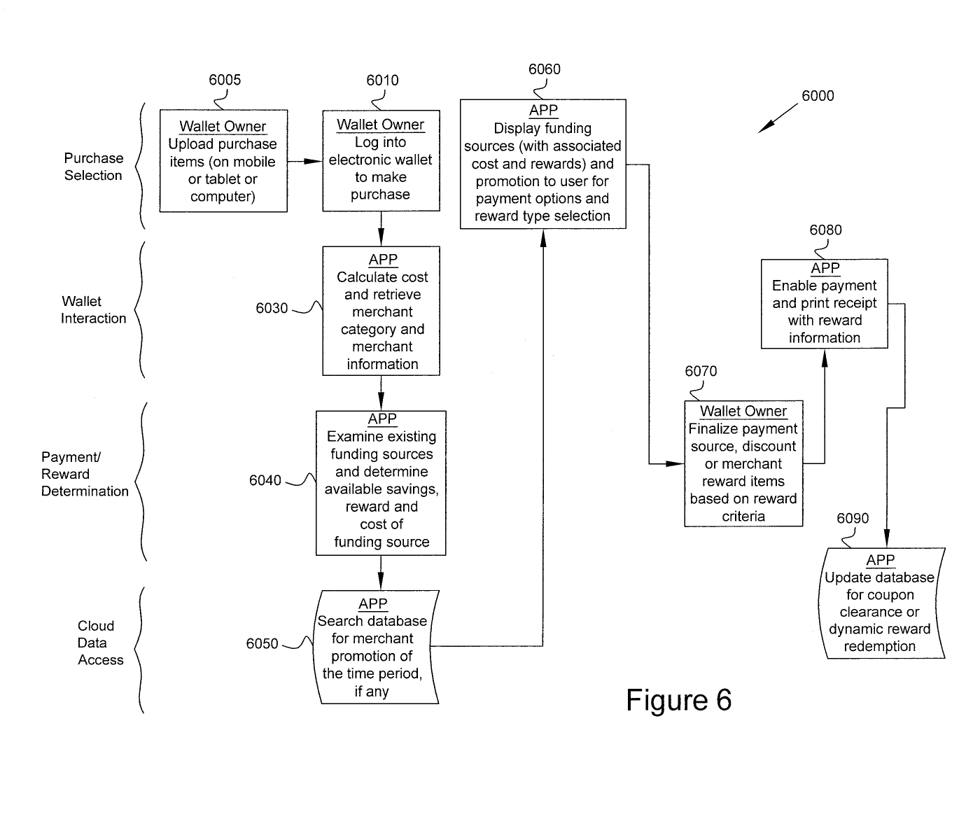

FIG. 6 is a flow diagram of a process 6000 for payment and reward optimization in the context of direct payment to a payee. Process 6000 may correspond to a scenario of a direct payment to a payee, in which scenario there is no merchant-funded reward (e.g., no possibility for the payor to receive free books from a book vendor payee based on a payment exceeding a predetermined amount). Various components of the flow diagram shown in FIG. 6 are similar to the flow diagram of FIG. 5, and only the differences are discussed in detail below.

Referring to FIG. 6, at block 6005, the wallet owner/user uses her user device 1100 to select one or more items to be purchased. Data regarding these item(s) may be uploaded to server 1200. At block 6010, the wallet owner/user logs into her electronic wallet to make payment, similar to block 5010 of FIG. 5. At block 6030, the application calculates the cost of the item(s) to be purchased and, similar to block 5030 of FIG. 5, retrieves a merchant identifier and merchant category identifier from the cloud (e.g., from wallet database 1400 or another database connected directly or indirectly to network 1300). Unlike block 5030, reward information is not retrieved at block 6030, because FIG. 6 corresponds to a scenario of no merchant-funded reward.

At block 6040, existing funding sources (payment options) are examined and available savings/rewards (e.g., existing electronic coupons stored in the wallet) and costs of funding sources are determined, similar to block 5040 of FIG. 5.

At block 6050, a database is searched to determine any applicable merchant promotion (promotional offer) for the present time period, similar to block 5050 of FIG. 5.

At block 6060, funding sources and any applicable promotional offer(s) are displayed to the wallet owner/user for funding source selection and coupon selection. Coupon(s) 7100 that were previously stored in the wallet (e.g., as shown in FIG. 7) may be retrieved and redeemed during the purchase selection process. Blocks 6070, 6080, and 6090 are similar to blocks 5070, 5080, and 5090, respectively, of FIG. 5.

In the processes shown in FIGS. 5 and 6, the discount (e.g., cash back amount) to which the consumer is entitled as a result of the transaction is immediately available and may be credited towards the present transaction itself, unlike other techniques that only make such rewards available for future transactions. Thus, in various embodiments of the present disclosure, consumers can flexibly select their payment options that yield immediate savings to them.

FIG. 8 is a flow diagram of a process in accordance with certain embodiments. After process 8000 begins, using at least one computer processor, a first input is received (block 8100) from a payor. The first input specifies a payee account for a transaction. At block 8200, for each payment source among a plurality of payment sources available to the payor, the application computes a processing cost associated with said payment source for the transaction, or a net cost to the payor associated with said payment source for the transaction, or both. At block 8300, an indication of one of the payment sources is displayed to the payor. The indication indicates that said one payment source is optimal according to a predetermined criterion. At block 8400, for each payment source, said associated processing cost and/or said associated net cost is/are displayed to the payor. At block 8500, a payment is processed to the payee account using one of the payment sources, which may be the payment source that was determined to be optimal or another payment source.

FIG. 9 is a flow diagram of another process in accordance with certain embodiments. After process 9000 begins, using at least one computer processor, a first input is received (block 9100) from a payor. The first input specifies one or more items to be purchased in a transaction. At block 9200, reward data associated with the payee account is retrieved. The reward data specifies one or more discounts available to the payor for the transaction (e.g., the 2% and 3% cash back discounts shown in Table 1 for credit cards X and Y, respectively). At block 9300, for each payment source among a plurality of payment sources available to the payor, the application computes a processing cost associated with said payment source for the transaction, or a net cost to the payor associated with said payment source for purchase of the items, or both. At block 9400, the application automatically determines one of the payment sources that is optimal according to a predetermined criterion. At block 9500, a payment for the items is processed to the payee account using one of the payment sources, wherein the payment uses at least one of the available discounts.

It is understood by those familiar with the art that the system described herein may be implemented in hardware, firmware, or software encoded on a non-transitory computer-readable storage medium.

The systems and processes are not limited to the specific embodiments described herein. In addition, components of each system and each process can be practiced independent and separate from other components and processes described herein. Each component and process also can be used in combination with other assembly packages and processes.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A computer-implemented method comprising:
using at least one computer processor, receiving a first input from a payor, the first input specifying a payee account for a transaction;
for each payment source among a plurality of payment sources available to the payor, computing at least one of a processing cost associated with said payment source for the transaction and a net cost to the payor associated with said payment source for the transaction;
displaying to the payor an indication of one of the payment sources, said indication indicating that said one payment source is optimal according to a predetermined criterion;
displaying to the payor, for each payment source, at least one of said associated processing cost and said associated net cost; and
processing a payment to the payee account using one of the payment sources.

2. The method of claim 1, further comprising:
retrieving merchant data associated with the payee account and reward data associated with the payee account, the merchant data including at least one of a merchant category and a merchant identifier, the reward data specifying one or more rewards available to the payor for the transaction, wherein the net cost associated with at least one of the payment sources is computed based on the merchant data; and
displaying information related to the one or more rewards to the payor.

3. The method of claim 2, further comprising receiving a second input from the payor, the second input selecting one of the rewards.

4. The method of claim 2, further comprising:
automatically searching a database, based on the merchant identifier, for a promotional offer presently available; and
displaying an available promotional offer to the payor.

5. The method of claim 1, wherein the predetermined criterion is net cost.

6. The method of claim 1, wherein the predetermined criterion is processing cost.

7. The method of claim 1, wherein the predetermined criterion is cash back rate.

8. The method of claim 1, wherein the predetermined criterion is contribution rate to a party different than the payor and different than the payee.

9. The method of claim 1, wherein processing the payment includes automatically processing the payment using said one payment source indicated as being optimal according to the predetermined criterion.

10. The method of claim 1, further comprising:
receiving a second input from the payor, the second input confirming said one payment source indicated as being optimal according to the predetermined criterion;
wherein processing the payment includes processing the payment using said one payment source.

11. The method of claim 1, further comprising:
receiving a second input from the payor, the second input selecting a payment source different than said one payment source indicated as being optimal according to the predetermined criterion;
wherein processing the payment includes processing the payment using the selected payment source.

12. The method of claim 1, further comprising displaying, for at least one of the payment sources, contribution data related to a contribution, contingent upon payment using said at least one of the payment sources, to a party different than the payor and different than the payee.

13. A non-transitory computer readable storage medium comprising instructions stored thereon, the instructions when executed causing a processor to perform the operations of:
receiving a first input from a payor, the first input specifying a payee account for a transaction;
for each payment source among a plurality of payment sources available to the payor, computing at least one of a processing cost associated with said payment source for the transaction and a net cost to the payor associated with said payment source for the transaction;
displaying to the payor an indication of one of the payment sources, said indication indicating that said one payment source is optimal according to a predetermined criterion;
displaying to the payor, for each payment source, at least one of said associated processing cost and said associated net cost; and
processing a payment to the payee account using one of the payment sources.

14. The non-transitory computer readable storage medium of claim 13, said instructions when executed further causing the processor to perform the operations of:
retrieving merchant data associated with the payee account and reward data associated with the payee account, the merchant data including at least one of a merchant category and a merchant identifier, the reward data specifying one or more rewards available to the payor for the transaction, wherein the net cost associated with at least one of the payment sources is computed based on the merchant data; and
displaying information related to the one or more rewards to the payor.

15. The non-transitory computer readable storage medium of claim 13, wherein processing the payment includes automatically processing the payment using said one payment source indicated as being optimal according to the predetermined criterion.

16. A computer-implemented method comprising:
using at least one computer processor, receiving a first input from a payor, the first input specifying one or more items to be purchased in a transaction;
retrieving reward data associated with the payee account, the reward data specifying one or more discounts available to the payor for the transaction;
for each payment source among a plurality of payment sources available to the payor, computing at least one of a processing cost associated with said payment source for the transaction and a net cost to the payor associated with said payment source for purchase of the items;
automatically determining one of the payment sources that is optimal according to a predetermined criterion; and
processing a payment for the items to the payee account using one of the payment sources, wherein the payment uses at least one of the available discounts.

17. The method of claim 16, further comprising retrieving merchant data associated with the payee account, the merchant data including at least one of a merchant category and a merchant identifier, wherein the net cost associated with at least one of the payment sources is computed based on the merchant data.

18. The method of claim 16, further comprising displaying to the payor an indication of said one payment source that is optimal according to the predetermined criterion.

19. The method of claim 16, further comprising displaying to the payor, for each payment source, said associated processing cost.

20. The method of claim 16, further comprising displaying to the payor, for each payment source, said associated net cost.
